(19) United States
(12) Patent Application Publication
(10) Pub. No.: US 2025/0186902 A1
(43) Pub. Date: Jun. 12, 2025

(54) MASS TRANSFER TRAY, USE THEREOF, COLUMN HAVING THE SAME, AND THERMAL SEPARATION PROCESS

(71) Applicant: BASF SE, Ludwigshafen am Rhein (DE)

(72) Inventors: Renhua GU, Shanghai (CN); Jun WANG, Shanghai (CN); Zhehui CAO, Shanghai (CN)

(21) Appl. No.: 18/840,938

(22) PCT Filed: Feb. 23, 2023
(86) PCT No.: PCT/CN2023/077896

§ 371 Date: Aug. 23, 2024

(30) Foreign Application Priority Data
Feb. 25, 2022 (WO) PCT/CN2022/077975

(51) Int. Cl. B01D 3/16; B01D 3/32; B01D 3/34; B01J 19/32

(52) U.S. Cl. CPC B01D 3/163; B01D 3/324; B01D 3/343; B01J 19/32; B01J 2219/32237; B01J 2219/32408; B01J 2219/3327

(57) ABSTRACT

The present invention relates to a mass transfer tray comprising a bottom plate, at least one gas transmission part and a liquid transmission part, wherein the mass transfer tray has at least one valve located in the liquid transmission part, relates to use of a mass transfer tray of the present invention in liquid separation process, relates to a column comprising the trays of the present invention, and relates to a thermal separation process, comprising performing thermal separation within the column of the present invention.

### TECHNICAL FIELD

The present invention relates to a mass transfer tray which is suitable as an internal in columns, in particular separating columns, for mass transfer between liquid and gas phases, and also to use of such mass transfer trays. The present invention further relates to a column for thermal treatment of fluid mixtures which comprises at least one such mass transfer tray, and also to a thermal separation process using such columns.

### BACKGROUND OF THE INVENTION

The results of chemical reactions are generally not pure substances but instead substance mixtures from which the target components have to be removed.

Frequently, separating processes which are carried out in separating columns are used for this purpose. In these separating columns, gaseous and liquid streams are conducted in co- or in countercurrent and, as a consequence of in equilibrium existing between the streams, heat and mass transfer takes place which eventually results in the desired separation in the separating column. In the context of this disclosure, such separating processes are to be referred to as thermal separating processes.

Examples of, and hence elements of, the expression “thermal separating processes” used in this document are fractional condensation, rectification (in both cases, ascending vapor phase is conducted in countercurrent to descending liquid phase; the separating action is based on the vapor composition at equilibrium being different from the liquid composition), absorption (at least one ascending gas is conducted in countercurrent to at least one descending liquid; the separating action is based on the different solubility of the gas constituents in the liquid) and desorption (the reverse process of absorption; the gas dissolved in the liquid phase is removed by lowering the partial pressure); and stripping (the partial pressure of the material dissolved in the liquid phase is lowered at least partly by passing a carrier gas through the liquid phase); alternatively or additionally (simultaneously as a combination), the lowering of the partial pressure can also be brought about by lowering the working pressure.

The separating columns in which these separating processes are conducted comprise separating internals. These internals have the purpose of increasing the surface area for the heat and mass transfer which brings about the separation in the separating column (“the transfer area”).

Useful internals of this kind include, for example, packings like structured packings, random packings as well as gauze packing and/or trays like bubble cap tray, dual flow tray as well as valve trays, which are also referred to as mass transfer trays. Frequently, separating columns used are those which comprise at least one sequence of mass transfer trays as a portion of the separating internals.

Unwanted solid particles, however, are formed on conventional tray plates. This solid formation can partly or completely block the passage opening of the mass transfer trays, which reducing separation efficiency of the trays. The operation of thermal separation process must be interrupted frequently. Plant worker need to climb into the narrow space between the trays in the column, wash the trays using certain solvent and clean the hard solid accumulators using hydro blasting. The space distance of a column tray is normally 300-600 mm. Depending on hazardous of applied chemical solvent, it can damage the health of workers. The waste particles launch into wastewater and bring further problem for environment protection.

The problematic property of applied chemicals and solvent is the tendency to unwanted solid formation at high temperature. Especially in the case of relatively large diameters of crossflow mass transfer trays, a notable liquid gradient naturally forms proceeding from the feed until the outlet. The result of this is that accumulation of solid particles is easier in regions with a relatively low liquid level. More washing effort is required for such region.

Therefore, there exists a need for a kind of mass transfer tray which is easier to clean.

### SUMMARY OF THE INVENTION

The present invention aims at overcoming at least one of the above-mentioned problems as well as others by providing a self-cleaning mass transfer tray, which can simplify cleaning work, and reduce or even eliminate the safety risks of manual cleaning in a confined space.

According to one aspect of the present invention, a mass transfer tray comprising a bottom plate, at least one gas transmission part and a liquid transmission part is provided. The mass transfer tray has at least one valve located in the liquid transmission part. When the valve is acted on by an ascending gas flow, the valve can be closed, and when the valve is not acted on by the ascending gas flow, it can be open due to an effect of its own gravity. The ascending gas flow generally exists during the separation operation process.

According to particular embodiments of the invention:
Optionally, the mass transfer tray comprises a plurality of valves, preferably substantially evenly distributed in the liquid transmission part;
Optionally, the bottom plate is provided with at least one through hole, each of which is positioned corresponding to a respective valve, each valve comprises a movable valve body (preferably “floating valve body”) and a holding unit for holding the valve body, and the valve is configured to have an open position where the valve body is held by the holding unit, and a closed position where the valve body closes the respective through hole in the bottom plate;
When the valve body is acted on by the ascending gas flow, it can be in its closed position. In case that the valve body is not acted on by the ascending gas flow, it can be in its open position under the action of its own gravity.
Optionally, the valve further comprises a cylindrical tube arranged coaxially to and around the holding unit;
Optionally, the holding unit is fixedly connected to the rear side of the bottom plate opposite to the front side thereof;
Optionally, the valve body is configured to block, in the closed position of the valve, the through hole from the rear side of the bottom plate;
Optionally, the valve body is configured in the form of a plate, and the plate of the valve is preferably configured as a flat plate or in an arched or domed shape;
Optionally, an aperture for pressure balance is formed at the center of the plate of the valve;
Optionally, the holding unit comprises a plurality of holding claws which are arranged circumferentially at a distance from one another;
Optionally, each holding claw is configured to be fixedly connected at its one end to the rear side of the bottom plate, and to hold, at its free claw end, the valve body when the valve is in the open position;
Optionally, the at least one gas transmission part is protruded from the front side of the bottom plate, and the liquid transmission part is adjacent to the at least one gas transmission part;
Optionally, the at least one gas transmission part is protruded and the bottom plate has at least one recess which is recessed away from the at least one protruding gas transmission part, and wherein the through hole and the valve are arranged in the recess;
Optionally, the mass transfer tray is a crossflow tray;
Optionally, the mass transfer tray and/or the valve are made of stainless steel or Carbon steel;
Optionally, there is a connection area between the gas transmission part and the bottom plate which connection area is rounded;
Optionally, the bottom plate comprises, on its rear side, a spacer located around the through hole, so that the valve body abuts against the spacer when the valve is in the closed position.

According to another aspect of the present invention, use of an above-mentioned mass transfer tray in liquid separation process, which may be one or more of distillation, rectification, stripping, and extraction, is provided.

According to yet another aspect of the present invention, a column for thermal treatment of fluid mixtures is provided, the column comprising a cylindrical vertical column body which forms a column cavity and a plurality of trays mounted in the column cavity and vertically spaced apart from one another, the trays comprising an above-mentioned mass transfer tray, for mass transfer between gas and liquid phases of the fluid mixtures.

According to yet another aspect of the present invention, a thermal separation process is provided, the process comprising performing thermal separation between at least one ascending gas and at least one descending liquid within a column as described above.

The present invention provides a self-cleaning mass transfer tray and a column for thermal treatment of fluid mixtures having such trays, by means of which it is possible to reduce solid formation of small particles in channels that form a liquid transmission part for conducting liquid. Specifically, the liquid transmission part is arranged on one side (a front side/upper side) of the bottom plate of the tray, through hole(s) may be formed in the liquid transmission part, and corresponding movable valve(s) may be provided on the opposite side (rear side/underside) of the tray(s). During maintenance washing, the valves can be moved to open (for example, due to the gravity of valve body and washing solvent as well as other force impact), and the liquid carrying small particles can flow downwards from the top of the valve and through the through hole onto the next lower tray in the column. After that, less or even no particles are left on the trays, and thus much less manual cleaning is required. During operation of the column, an amount of gas flowing through the tray, that is to say, the down-top gas pressure across the valve body is greater than the liquid static pressure on the tray, and the valve(s) is/are moved to close so as to block the through hole(s). Then the gas is avoided from flowing past the through hole(s) of the valve(s). Small aperture at the center of arched or domed floating plate works like a parachute balancing the pressure drop of plate both sides.

### BRIEF DESCRIPTION OF THE DRAWINGS

Other features and advantages of the present invention will emerge more clearly from the following detailed description of embodiments of the inventive mass transfer tray and its use, the column and the process according to the invention, these examples being given for purely illustrative and not limiting purposes only in connection with the appended drawings in which:

FIG. 1 schematically illustrates an exemplary embodiment of a mass transfer tray according to the present invention in a top view,

FIG. 2 is a cross-section view of a part of the mass transfer tray shown in FIG. 1, with a valve opened,

FIG. 3 schematically illustrates the detail of the valve shown in FIG. 2,

FIG. 4 is a cross-section view of a part of the mass transfer tray shown in FIG. 1, with a valve closed,

FIG. 5 schematically illustrates the detail of the valve shown in FIG. 4,

FIG. 6 is a cross-section view of an exemplary embodiment of a valve according to the present invention,

FIG. 7 is a cross-section view of another exemplary embodiment of a valve according to the present invention, and

FIG. 8 schematically shows an exemplary embodiment of a column for thermal treatment of fluid mixtures according to the present invention.

### DETAILED DESCRIPTION OF THE INVENTION

The present invention will be described below with reference to the embodiments, which are shown in the drawings. The same reference numbers, if possible, are used throughout the drawings to indicate the same or similar components.

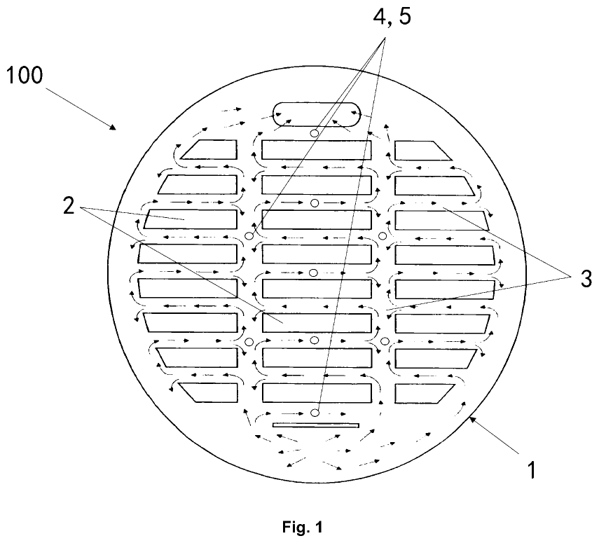

FIG. 1 is a top view of an exemplary embodiment of a mass transfer tray according to the present invention. The mass transfer tray 100, typically a crossflow tray, is suitable as an internal in separating columns (see FIG. 8) for mass transfer between liquid and gas phases.

The purpose of a mass transfer trays is to provide areas having essentially continuous liquid phases in the separating column in the form of liquid layers that form thereon. The surface of the vapor and/or gas stream which ascends within the liquid layer and is distributed in the liquid phase is then the crucial transfer area.

The mass transfer trays used are particularly frequently those having forced liquid flow.

The forced liquid flow is achieved by the mass transfer trays having at least one downcomer (drain), through which the liquid flows from the upper tray to the lower tray (feed) irrespective of the flow path of the vapor in a tray column. The horizontal liquid flow over the transfer tray from feed to drain is selected according to the task in terms of process engineering. The gas or the vapor passes through the open cross sections of the tray.

If, for example, only half of a (preferably circular) mass transfer tray has at least one downcomer, and, in a sequence of at least two identical mass transfer trays of this kind, the mass transfer trays in a separating column are arranged one on top of another such that two mass transfer trays in the separating column, one of which follows the other in the downward direction, are each mounted offset (turned) by 180° relative to one another about the longitudinal axis of the column, such that the downcomers thereof are on opposite sides (in opposite halves) of the separating column, the liquid which descends from an upper mass transfer tray through the at least one downcomer thereof to the mass transfer tray mounted below must necessarily (i.e. of necessity) flow on this lower mass transfer tray, viewed over the lower mass transfer tray, from the at least one feed area of the at least one downcomer of the upper mass transfer tray (that mounted above) (from the at least one feed through the at least one downcomer of the upper mass transfer tray) to the at least one downcomer of this lower mass transfer tray. In other words, the descending liquid from the upper to the lower tray is inevitably conducted across the tray from the at least one feed to the at least one outlet.

Such a liquid flow on a mass transfer tray within a sequence of identical mass transfer trays shall be referred to in this disclosure as a crossflow, the sequence of such identical mass transfer trays as a sequence of identical crossflow mass transfer trays, and the individual mass transfer trays within the sequence as crossflow mass transfer trays.

Tunnel or Thormann tray is a type of cross flow bubble-cap tray. The cross sections of passage orifice, chimney and bubble cap (hood) are rectangular. Gas passages with their bubble caps are arranged one after another within rows arranged alongside one another, with the longer rectangular edge aligned parallel to the crossflow direction of the liquid.

In the embodiment illustrated in FIG. 1, the tray 100 has a bottom plate 1, at least one gas transmission part 2 and a liquid transmission part 3. The gas and the liquid transmission parts 2, 3 are arranged on one side (front side) of the bottom plate 1 of the tray 100. The liquid transmission part 3 may consist of separated channels arranged in parallel to one another which conduct the liquid. The gas transmission parts 2, also referred to as gas passages, may be arranged adjacent to and between the channels and may be protruded from the front side of the bottom plate 1. Particularly, the gas transmission parts 2 may be covered by hoods (not shown).

Cross flow tunnel tray or Thormann tray is used for high gas loadings and middle to low liquid loadings. The liquid on a crossflow tunnel tray or Thormann tray is driven in a meandering manner from feed to the outlet. It is advantageous in longer residence time and forced vapor direction and thus better separation efficiency.

The tray 100 may further comprise at least one valve 5 located in the liquid transmission part 3. For tray column with large diameters, the tray 100 may be provided with a plurality of valves 5. Preferably at least three, more preferably at least five, for example five to ten or more valves 5, may be provided on the tray 100.

Referred to FIGS. 1-6, the bottom plate 1 may be provided with at least one through hole 4. Corresponding to each through hole 4, one respective valve 5 is positioned in the liquid transmission part 3.

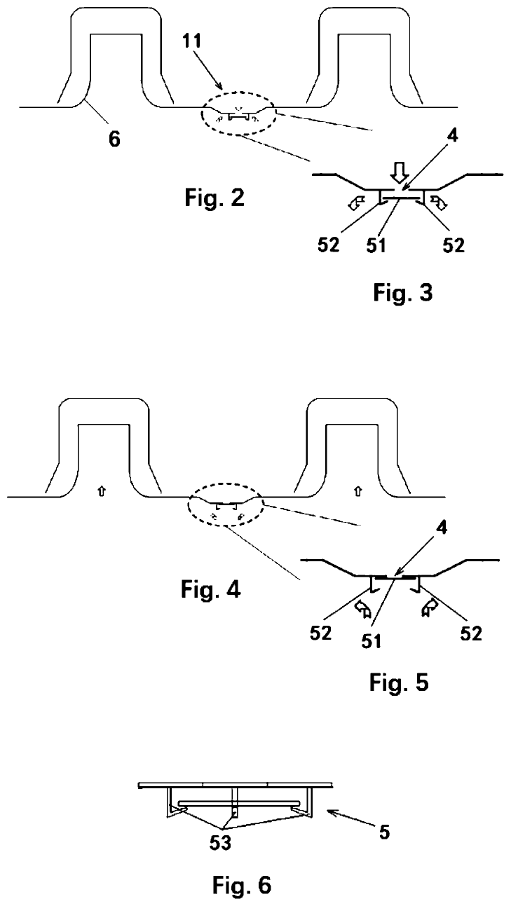

As can be seen from FIGS. 2-7, each valve 5 may comprise a movable valve body 51, 51′ and a holding unit 52 for holding the valve body. The valve 5 may be configured to have an open position (as best shown in FIG. 3) and a closed position (as best shown in FIG. 5).

During cleaning/washing, the down-top gas pressure across the valve body 51 is reduced or even eliminated, the valve body 51, 51′ can rest on and be held by the holding unit 52, the valve 5 is in its open position. If, for example, the down-top gas pressure across the valve body 51, 51′ pushes the valve body 51, 51′ upwards, blocking the respective through hole 4 from the rear side of the bottom plate 1, the valve 5 is moved into its closed position.

The holding unit 52 may be fixedly connected to the rear side of the bottom plate 1 opposite to the front side thereof.

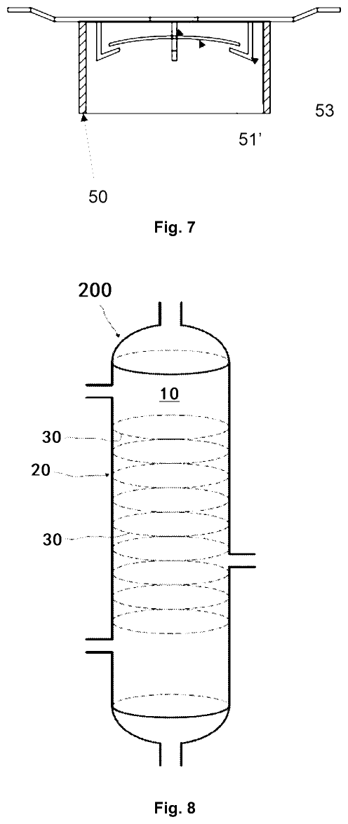

The valve body 51, 51′ can be non-exclusively configured in the form of a plate. In the embodiment shown in FIG. 6, the valve body 51 is configured as a flat plate. FIG. 7 shows another embodiment in which the valve body 51′ (i.e., the valve plate) is configured in an arched or domed shape.

Preferably, as shown in FIG. 7, an aperture 54 with a diameter of for example several millimeters may be formed at the center of the valve body 51′. The aperture 54 can balance the gas pressure drop of both sides (i.e., top and bottom sides) of the valve body 51′.

Clearly the aperture 54 may also be formed in the valve body 51 shown in FIG. 6.

As can be seen from FIG. 7, the valve 5 may further comprise a cylindrical tube 50 arranged coaxially to and around the holding unit 52. The tube 50 can guide the gas flow towards the valve 5, ensuring the valve body 51, 51′ to be pressed upwards to close the valve 5.

Referred back to FIG. 6, the holding unit 52 may comprise a plurality of holding claws 53. The holding unit 52 preferably comprise 3 to 8, more preferably 3 to 6 claws. The plurality of holding claws 53 are preferably arranged circumferentially at a distance from one another.

Each holding claw 53 can be non-exclusively configured to be fixedly connected at its one end to the rear side of the bottom plate 1, and to hold, at its free claw end, the valve body 51 when the valve 5 is in the open position.

The bottom plate 1 preferably has at least one recess or groove 11 which is away from the protruding gas transmission part 2. It is advantageous that the through hole 4 and the corresponding valve 5 are arranged in one respective recess or groove 11. During the operation of an installation for example separating column having such a bottom plate, the recesses or grooves can collect solid accumulation. Moreover, during cleaning the liquid carrying small particles can flow more smoothly downwards from the top of the valve 5 and through the through hole 4 onto the next lower tray, without any obstacles or difficulty.

The mass transfer tray 100 and/or the valve 5 can be non-exclusively made of stainless steel or Carbon steel.

As best shown in FIG. 2, the connection area 6 between the gas transmission part 2 and the bottom plate 1 is rounded. This is advantageous in reducing dead zone and thus reducing potential of solid accumulation and suppressing solid formation on trays.

The bottom plate 1 preferably comprises, on its rear side, a spacer (not shown) located around the through hole 4 so that the valve body 51 abuts against the spacer when the valve 5 is in the closed position. The spacer may be preferably configured as ring-shaped. Due to such a spacer, the valve 5 can close only to such an extent that the space left permits vigorous mixing of the horizontal gas outflow with the crossflowing liquid. The spacer can also counteract sticking of the valve disk on the tray. Moreover, the stroke height of the valve body 51 can be adjusted in accordance with the gas loadings by means of various spacers with different thickness.

FIG. 8 schematically shows an exemplary embodiment of a column for thermal treatment of fluid mixtures according to the present invention. The column 200 may comprise a cylindrical vertical column body 20 which forms a column cavity 10 and a plurality of trays 30 mounted in the column cavity 10 and vertically spaced apart from one another. The trays comprise at least one mass transfer tray 100 as described above, preferably a sequence of mass transfer trays 100, for mass transfer between gas and liquid phases of the fluid mixtures.

A sequence of mass transfer trays is understood to mean a sequence (a succession) of at least two mass transfer trays generally of the same design (i.e., identical), arranged one above another in the separating column. Advantageously for application purposes, the clear distance between two immediately successive mass transfer trays in such a series (sequence) of mass transfer trays is uniform (meaning that the mass transfer trays are arranged equidistantly one above another in the separating column).

The material of the separating column may be stainless steel, for example.

The present invention also relates to use of the above-mentioned mass transfer tray 100 in a liquid separation process. Such a liquid separation process can be non-exclusively one or more of distillation, rectification, stripping, and extraction, etc.

The present invention also relates to a thermal separation process. The thermal separation process can non-exclusively comprise performing thermal separation between at least one ascending gas and at least one descending liquid within the above-mentioned column.

In an embodiment, the at least one ascending gas and/or at least one descending liquid comprise maleic anhydride or (meth) acrylic monomers.

Maleic anhydride is prepared by catalytic gas phase oxidation of C4 precursor compounds. In general, the temperature of the product gas mixture leaving the gas phase oxidation is 350 to 550° C., frequently, 400 to 500° C. (in) direct cooling of the mixture cools the hot mixture to a temperature of 100 to 180° C. The operation pressure existing in the column is general 5 to 15 bar, frequently 5 to 13 bar and in many cases 10 to 11 bar.

Typically, the product gas mixture from catalytical gas oxidation has following contents:
1%-30% by weight of maleic anhydride,
0.05%-10% by weight of Maleic acid,
0.05%-10% by weight of fumaric acid, and
0.05%-10% by weight of water.

For instance, removal of maleic anhydride from the product gas mixture from catalytic gas phase oxidation can be conducted in a way that maleic anhydride mixture is first removed by absorption into a solvent (water or organic solvent) and subsequently the maleic anhydride is obtained by thermal separation process like adsorption or gas stripping.

### INDUSTRIAL APPLICABILITY

According to the present invention, a novel and inventive self-cleaning mass transfer tray is provided with a movable valve which is installed on a rear side of a bottom plate of the tray at a position corresponding to the liquid transmission part, which is composed of separated channels for conducting liquid.

Through holes are formed in the bottom plate in the channels which are arranged on the front side of the bottom plate of the tray, and at least one valve is mounted on the opposite side/rear side of the bottom plate. For each valve, a moveable (preferably “floating”) valve body, preferably in the form of a valve plate, is located between and constrained by the bottom plate and a holding unit of the valve connected to the rear side of the bottom plate. The holding unit may consist of several claws and the valve body, which may be a flat plate or an arched or domed one, can rest on the free ends of the claws when the valve is in its open position.

The valve plate can reach a stroke height as a function of the gas loading, until it blocks the through hole in the bottom plate of the tray so that the valve arrives at its closed position.

During cleaning or shutting down for clean, the movable valve plate falls down to the bottom of valve. Small particles from washing sweeps forwards with washing stream from the clearance of the claws of the valve, especially in the regions with significant liquid gradient with big diameter.

Various exemplary embodiments of the invention are described herein. Reference is made to these examples in a non-limiting sense. They are provided to illustrate more broadly applicable aspects of the invention. Various changes may be made to the invention described and equivalents may be substituted without departing from the true spirit and scope of the invention. In addition, many modifications may be made to adapt a particular situation, material, composition of matter, process, process act(s) or step(s) to the objective(s), spirit or scope of the present invention. Further, as will be appreciated by those with skill in the art that each of the individual variations described and illustrated herein has discrete components and features which may be readily separated from or combined with the features of any of the other several embodiments without departing from the scope or spirit of the present inventions. All such modifications are intended to be within the scope of claims associated with this disclosure.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in claims associated hereto, the singular forms “a”, “an”, “said”, and “the” include plural referents unless the specifically stated otherwise. In other words, use of the articles allows for “at least one” of the subject item in the description above as well as claims associated with this disclosure. It is further noted that such claims may be drafted to exclude any optional element. As such, this statement is intended to serve as antecedent basis for use of such exclusive terminology as “solely”, “only” and the like in connection with the recitation of claim elements, or use of a “negative” limitation. In addition, where a range of values is provided, it is understood that every intervening value, between the upper and lower limit of that range and any other stated or intervening value in that stated range, is encompassed within the invention.

Without the use of such exclusive terminology, the term “comprise/comprising” in claims associated with this disclosure shall allow for the inclusion of any additional element-irrespective of whether a given number of elements are enumerated in such claims, or the addition of a feature could be regarded as transforming the nature of an element set forth in such claims. Except as specifically defined herein, all technical and scientific terms used herein are to be given as broad a commonly understood meaning as possible while maintaining claim validity.

1.-19. (canceled)

20. A mass transfer tray comprising a bottom plate, at least one gas transmission part and a liquid transmission part, wherein the mass transfer tray has at least one valve located in the liquid transmission part.

21. The mass transfer tray according to claim 20, wherein the mass transfer tray has a plurality of valves.

22. The mass transfer tray according to claim 20, wherein
the bottom plate is provided with at least one through hole, each of which is positioned corresponding to a respective valve,
each valve comprises a movable valve body and a holding unit for holding the valve body, and the valve is configured to have an open position where the valve body is held by the holding unit, and a closed position where the valve body closes the respective through hole in the bottom plate.

23. The mass transfer tray according to claim 22, wherein the valve further comprises a cylindrical tube arranged coaxially to and around the holding unit.

24. The mass transfer tray according to claim 22, wherein the holding unit is fixedly connected to the rear side of the bottom plate opposite to the front side thereof.

25. The mass transfer tray according to claim 22, wherein the valve body is configured to block, in the closed position of the valve, the through hole from the rear side of the bottom plate.

26. The mass transfer tray according to claim 22, wherein the valve body is configured in the form of a plate.

27. The mass transfer tray according to claim 26, wherein an aperture for pressure balance is formed at the center of the plate of the valve.

28. The mass transfer tray according to claim 22, wherein the holding unit comprises a plurality of holding claws which are arranged circumferentially at a distance from one another.

29. The mass transfer tray according to claim 28, wherein each holding claw is configured to be fixedly connected at its one end to the rear side of the bottom plate, and to hold, at its free claw end, the valve body when the valve is in the open position.

30. The mass transfer tray according to claim 20, wherein the at least one gas transmission part is protruded from the front side of the bottom plate, and the liquid transmission part is adjacent to the at least one gas transmission part.

31. The mass transfer tray according to claim 20, wherein the at least one gas transmission part is protruded and the bottom plate has at least one recess which is recessed away from the at least one protruding gas transmission part, and wherein the through hole and the valve are arranged in the recess.

32. The mass transfer tray according to claim 20, wherein the mass transfer tray is a crossflow tray.

33. The mass transfer tray according to claim 20, wherein the mass transfer tray and/or the valve are made of stainless steel or Carbon steel.

34. The mass transfer tray according to claim 20, wherein there is a connection area between the gas transmission part and the bottom plate, which connection area is rounded.

35. The mass transfer tray according to claim 22, wherein the bottom plate comprises, on its rear side, a spacer located around the through hole, so that the valve body abuts against the spacer when the valve is in the closed position.

36. Use of a mass transfer tray according to claim 20 in liquid separation process which is one or more of distillation, rectification, stripping, and extraction.

37. A column for thermal treatment of fluid mixtures, comprising a cylindrical vertical column body which forms a column cavity and a plurality of trays mounted in the column cavity and vertically spaced apart from one another, the trays comprising a mass transfer tray according to claim 20, for mass transfer between gas and liquid phases of the fluid mixtures.

38. A thermal separation process, comprising performing thermal separation between at least one gas ascending and at least one liquid descending within a column according to claim 37.
